(19) United States
(12) Patent Application Publication
(10) Pub. No.: US 2010/0101028 A1
(43) Pub. Date: Apr. 29, 2010

(54) MULTI-FUNCTION TOOL INCLUDING A LETTER OPENER AND STAPLE REMOVER

(75) Inventor: Erwin Cheldin, Woodland Hills, CA (US)

Correspondence Address: KELLY LOWRY & KELLEY, LLP, 6320 CANOGA AVENUE, SUITE 1650, WOODLAND HILLS, CA, 91367, US

(73) Assignee: ERKIE, INC., Woodland Hills, CA (US)

(21) Appl. No.: 12/260,922

(22) Filed: Oct. 29, 2008

(51) Int. Cl. B26B 11/00; B25B 15/00

(52) U.S. Cl. 7/160; 7/165

(57) ABSTRACT

The present invention resides in a multi-function tool which combines a staple remover with a letter opener and a screwdriver. The letter opener is formed integrally with the elongated body of the staple remover. The screwdriver has a removable shaft including a slotted drive end and a crosshead drive end on a hex-shaft which is insertable into a mated hex cavity on the body of the staple remover.

### BACKGROUND OF THE INVENTION

The present invention relates to office tools such as letter openers, staple removers and screwdrivers. More particularly, the present invention relates to a multi-function tool which includes a letter opener, a staple remover and a screwdriver.

Staple removers are well known and are provided in two general forms, a double-jawed staple remover and a staple puller. The staple puller is generally comprised of a staple removing portion which is inserted beneath the staple, and a handle extending therefrom. After inserting the staple removing portion of the puller beneath the staple, the handle is pushed downwardly to force the staple upwardly.

There are also two general types of manually operated letter openers. The first is an elongated blade having a tapered point and rather dull edges. The blade is usually formed of metal and the tapered point is placed in an opening of the envelope flap and an edge of the blade forced through the paper flap of the envelope to reveal the contents of the envelope. The second type of letter opener is a handle piece, usually comprised of hardened plastic, having a narrow channel formed by the handle piece and a protrusion of the handle. A cutting blade is positioned within the channel. An end of the protrusion is inserted under the envelope flap which is guided through the channel and slit open by the cutting blade to reveal the contents of the envelope.

Letters are typically received in bulk periodically during the day or week. A person opening the letter envelopes, such as a receptionist or secretary must find a letter opener or have a space reserved for a letter opener and the staple remover so as not to misplace or lose them. At times, the person opening the envelopes may not quickly find the letter opener and resorts instead to using other objects not designed to open letters, possibly resulting in excessive tearing of the envelope or even damage to the contents of the envelope.

Oftentimes, a person working in an office which may at times have need of a letter opener and/or a staple remover, may also have need of a screwdriver. If there are three separate tools to meet these needs, time may be wasted looking for one of them or they may be separated and moved to different locations.

Accordingly, what is needed is a multi-function tool which couples a letter opener and a staple remover with a screwdriver in order to alleviate the inconveniences of using/storing these devices separately. The present invention fulfills these needs and provides other related advantages.

### SUMMARY OF THE INVENTION

The present invention is directed to a multi-function tool comprising a push-style staple remover having an elongated body, a letter opener associated with and extending radially from the body of the staple remover, and a screwdriver removably associated with an end of said body. The letter opener and screwdriver are preferably integrally formed with the body of the staple remover.

The screwdriver comprises a slotted or crosshead design. Further, the screwdriver preferably comprises an elongated hex-shaft having a slotted design on a first end and a crosshead design on an opposite second end. The elongated hex-shaft is removably inserted into a hex cavity within the body of the staple remover.

The letter opener includes a finger element which extends generally parallel to the elongated body so as to form a channel. A cutting element is positioned within the channel. The cutting element preferably comprises a razor blade.

The push-style staple remover includes a rigid guide which extends beyond and is intermediate to an upper staple support clamp and a lower wedge. The guide is substantially planar and tapers to a forked end.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is an elevated perspective view of a multi-function tool of the present invention;

FIG. 2 is an end view of a multi-function tool of the present invention;

FIG. 3 is an opposite end view of a multi-function tool of the present invention;

FIG. 4 is a side view of a multi-function tool of the present invention;

FIG. 5 is an opposite side view of a multi-function tool of the present invention;

FIG. 6 is a top view of a multi-function tool of the present invention;

FIG. 7 is a bottom view of a multi-function tool of the present invention;

FIG. 8 is an elevated perspective view of an alternative embodiment of a multi-function tool of the present invention; and

FIG. 9 is a partially exploded perspective view of a multi-function tool of the present invention.

### DETAILED DESCRIPTION OF THE PREFERRED EMBODIMENTS

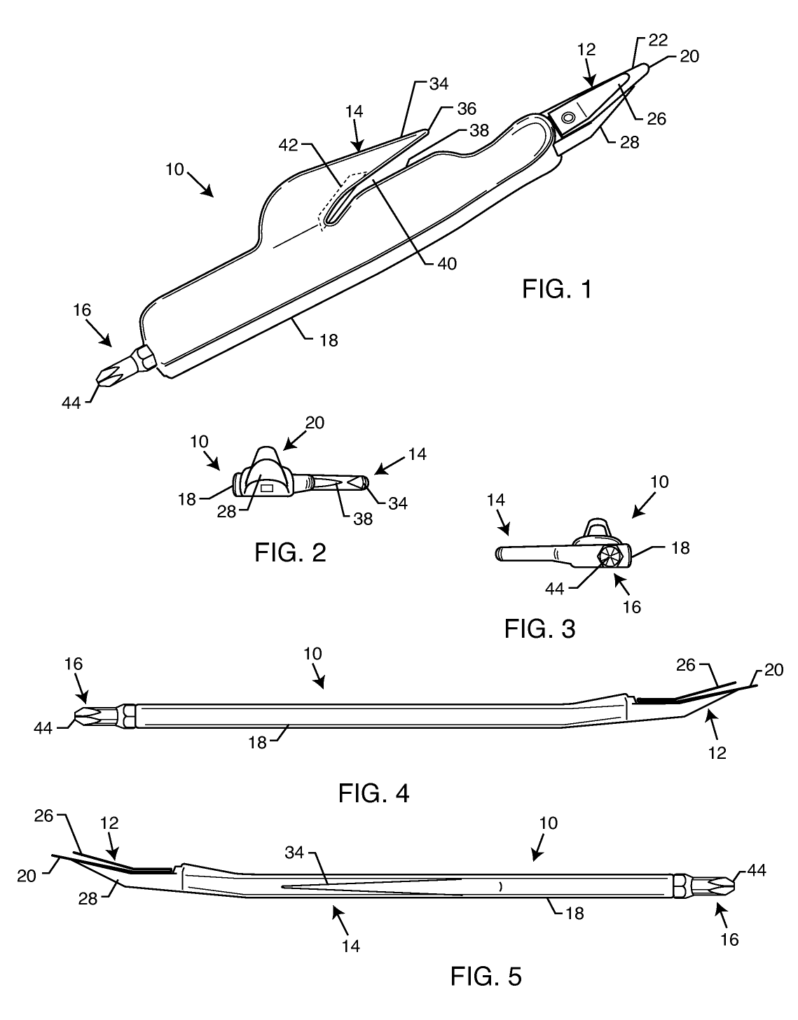

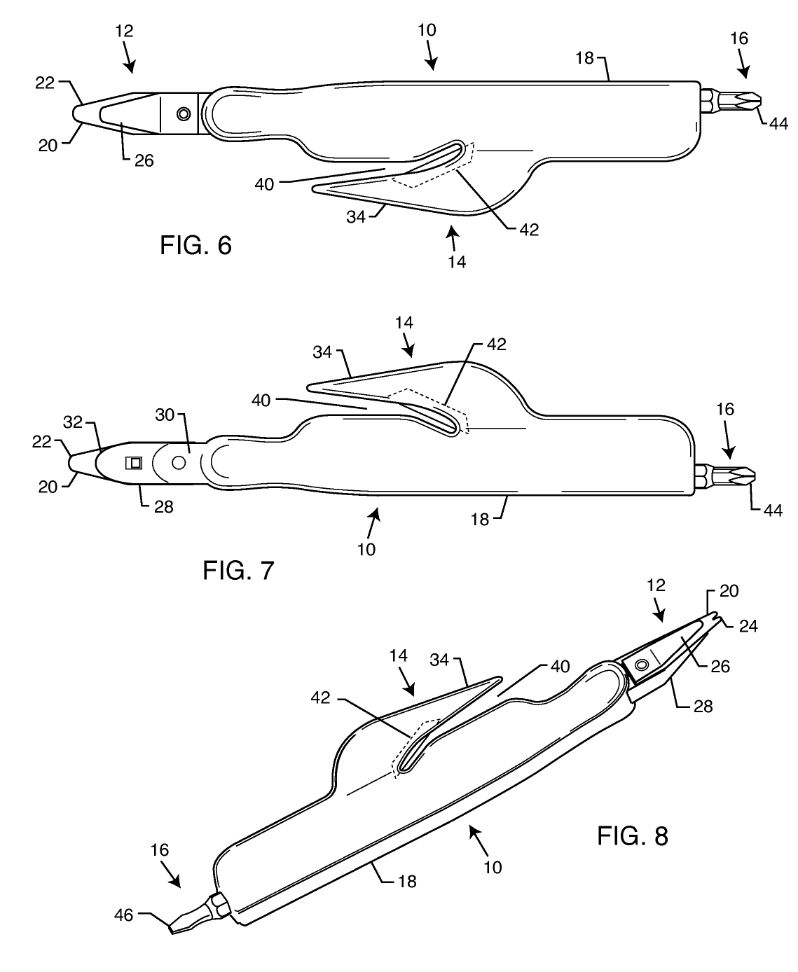

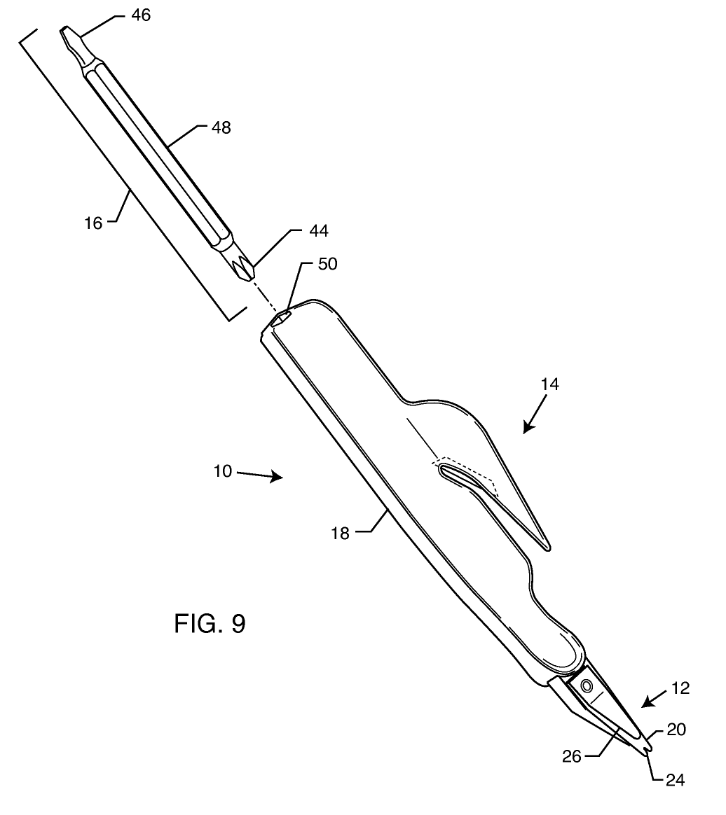

As shown in the drawings for purposes of illustration, the present invention is concerned with a multi-function tool, generally referred to by the reference number 10 in FIGS. 1-9. The multi-function tool 10 combines a staple remover 12, a letter opener 14 and a screwdriver 16 into one to grant more convenience to a user, such as an office worker, who periodically needs to utilize more than one of these devices at nearly the same time.

In accordance with the invention and with reference to FIGS. 1 and 4-7, the staple remover 12 is formed with an elongated body 18, preferably made from a hard plastic. The staple remover 12 includes a rigid guide element 20 which tapers to a rounded end 22 (FIG. 1) or a forked end 24 (FIG. 8) to facilitate the insertion of the guide element 20 beneath a staple while also preventing ripping or tearing of the stapled article. The guide element 20 is relatively thin and generally rigid so as to be easily inserted beneath a staple. The guide element 20 is generally comprised of metal, such as stainless steel, in order to withstand the forces applied to it and also to resist corrosion. Although generally planar, the guide element 20 may also be angled upwardly in order to further facilitate its insertion beneath an engaged staple.

Positioned above the guide element 20 is at least one support clamp 26 which also extends from the body 18. Typically, the support clamp 26 does not extend as far from the body 18 as the guide element 20. The support clamp 26 acts to clasp removed staples. The support clamp 26 also supports the guide element 20 during staple removal so that the guide element 20 does not bend or become otherwise distorted due to the forces applied to it. The support clamp 26 is typically comprised of the same material, usually stainless steel, as the guide 20. However, the support clamp 26 may also be comprised of a hard plastic, as the body 18.

Positioned below the guide element 20 is a wedge 28 which comprises an extension of the body 18, along the underside of the guide 20. The wedge 28 has a thicker base 30 near the body 18 and is beveled along the underside thereof to a thinner point 32. The wedge 28 aids the user in the insertion of the guide element 20 beneath the staple, and also acts as a lever when disengaging the staple.

The staple remover 12 is used by forcibly inserting the guide element 20 beneath the staple. The user may utilize the beveled wedge 28 in order to aid in the insertion of the guide element 36. The tapered wedge 28 acts on the legs of the staples to push them downward and on the staple to push it upward as the guide element 20 is forcibly inserted. Once inserted, the user continues to thrust the staple remover 12 through the staple, wedging the legs further apart until they release from the article. If the staple is not removed by the thrusting action, the body 18 is pushed downwardly in a lever-like manner forcing the staple further upward from the article.

The letter opener 14, as illustrated in FIGS. 1, 6 and 7, generally comprises a finger protrusion 34 extending radially from the body 18, spaced apart from the body 18, and tapered to a point 36. The finger 34 is typically a generally planar, one-piece member integrally formed with the body 18 on one side thereof, but is not limited to a particular shape, width or size. The space between an inner edge 38 of the finger 34 and the body 18 forms a paper accepting channel 40. A cutting element 42, preferably a straight metal razor blade, is positioned within the paper accepting channel 40.

To cut open an envelope, the tapered point 36 of the finger protrusion 34 is inserted into a small opening of a flap of the envelope. The finger protrusion 36 acts as a guide, feeding the flap of the envelope into the paper accepting channel 40 until the paper abuts the cutting element 42 where the flap is sliced open to reveal the contents of the envelope.

The screwdriver 16, as illustrated in FIGS. 1 and 4-9, may comprise a crosshead driver 44 (FIG. 1) and/or a slotted driver 46 (FIG. 8). Preferably, the screwdriver 16 comprises an elongated hex-shaft 48 with a crosshead driver 44 at one end and a slotted driver 46 at the other end. A hex cavity 50 is integrally formed with the body 18 of the staple remover 12. The hex-shaft 48 is removably inserted into the hex cavity 50 so as to be held fast. The hex cavity 50 is closely mated to the shape of the hex-shaft 48 so as to prevent rotation of the hex-shaft 48 within the hex cavity 50. The hex-shaft 48 is reversible such that either the crosshead driver 44 or the slotted driver 46 protrudes from the hex cavity 50.

Referring now to FIGS. 1 and 4-9, the letter opener 14 and screwdriver 16 may be formed integrally, by molding or permanent attachment, with the body 18 of the staple remover 12 to form the tool 10. The body 18 of the staple remover 12 may bulge and extend towards the finger protrusion 34 in order to form the paper accepting channel 40. Alternatively, the paper accepting channel 40 may be formed between the finger protrusion 34 and the standard body 18 of the staple remover 12.

Although several embodiments have been described in detail for purposes of illustration, various modifications may be made without departing from the scope and spirit of the invention. Accordingly, the invention is not to be limited, except as by the appended claims.

What is claimed is:

1. A multi-function tool, comprising:
a push style staple remover having an elongated body;
a letter opener associated with and extending radially from the body of the staple remover; and
a screwdriver removably associated with an end of said body.

2. The tool of claim 1, wherein the screwdriver comprises a slotted or crosshead design.

3. The tool of claim 1, wherein the screwdriver comprises an elongated hex-shaft having a slotted design on a first end and a crosshead design on an opposite second end, the elongated hex-shaft being removably inserted into a hex cavity within the body of the staple remover.

4. The tool of claim 1, wherein the letter opener and screwdriver are integrally formed with the body of the staple remover.

5. The tool of claim 1, wherein the letter opener includes a finger which extends generally parallel to the elongated body so as to form a channel, and a cutting element positioned within the channel.

6. The tool of claim 5, wherein the cutting element comprises a razor blade.

7. A multi-function tool, comprising:
a push style staple remover having an elongated body;
a letter opener integrally formed with and extending radially from the body of the staple remover; and
a screwdriver comprising an elongated hex-shaft having a slotted design on a first end and a crosshead design on an opposite second end, the elongated hex-shaft being removably inserted into a hex cavity integrally formed within an end of the body of the staple remover.

8. The tool of claim 7, wherein the letter opener includes a finger which extends generally parallel to the elongated body so as to form a channel, and a cutting element positioned within the channel.

9. The tool of claim 8, wherein the cutting element comprises a razor blade.

10. The tool of claim 7, wherein the staple remover includes a rigid guide which extends beyond and is intermediate an upper staple support clamp and a lower wedge.

11. A multi-function tool, comprising:
a push style staple remover having an elongated body;
a letter opener associated with and extending radially from the body of the staple remover, wherein the letter opener includes a finger which extends generally parallel to the elongated body so as to form a channel, and a cutting element positioned within the channel; and
a screwdriver comprising an elongated hex-shaft having a slotted design on a first end and a crosshead design on an opposite second end, the elongated hex-shaft being removably inserted into a hex cavity within an end of the body of the staple remover.

12. The tool of claim 11, wherein the cutting element comprises a razor blade.

13. The tool of claim 11, wherein the staple remover includes a rigid guide which extends beyond and is intermediate an upper staple support clamp and a lower wedge; and
wherein the guide is substantially planar and tapers to a forked end.
